(19) United States
(12) Patent Application Publication
(10) Pub. No.: US 2025/0353444 A1
(43) Pub. Date: Nov. 20, 2025

(54) COLLAPSIBLE CARRIER

(71) Applicant: David Stanley Steele, Shannon Brook (AU)

(72) Inventor: David Stanley Steele, Shannon Brook (AU)

(21) Appl. No.: 19/208,038

(22) Filed: May 14, 2025

(30) Foreign Application Priority Data
May 15, 2024 (AU) 2024901425

(51) Int. Cl. B60R 9/06; B60R 9/10

(52) U.S. Cl. CPC B60R 9/06; B60R 9/10

(57) ABSTRACT

A collapsible carrier, designed for attachment to a hitch or drawbar, includes: a central portion, a first carrier arm hinged to the central portion, a first end portion linked to the first carrier arm, a second carrier arm hinged to the central portion, and a second end portion attached to the second carrier arm. This carrier is capable of transitioning between two configurations: an extended configuration and a stowed configuration. In the extended configuration, the central portion, first carrier arm, and second carrier arm align along a common axis. In the stowed configuration, the central portion, the first carrier arm and the second carrier arm are non-coplanar.

### RELATED APPLICATIONS

This application claims priority of Australian Patent Application No. 2024901425, filed May 15, 2024, which is hereby incorporated herein by reference in its entirety.

### TECHNICAL FIELD

The present invention relates to a carrier designed for transportation of motorbikes and bicycles. More specifically, the invention pertains to a collapsible carrier that can be connected to the hitch of a vehicle or the drawbar of a trailer, featuring a foldable clamshell design for compactness and ease of storage.

### BACKGROUND

Any references to methods, apparatus or documents of the prior art are not to be taken as constituting any evidence or admission that they formed, or form part of the common general knowledge.

The transportation of two-wheeled vehicles, such as motorcycles and bicycles in particular, can be a challenging task, especially for those who do not have a dedicated trailer or sufficient space in their vehicle.

Traditional carriers are often simple straight rack-style systems that are difficult to use and lack versatility for both transport and storage. Such carriers often lack the necessary features to securely hold the motorcycle or bicycle in place during transportation, leading to damage or injury.

Additionally, these carriers can be bulky and difficult to store when not in use. Therefore, there is a need for an improved carrier that is easy to use, secure, and stow when not in use.

### SUMMARY OF INVENTION

In an aspect, the invention provides a collapsible carrier adapted for connecting to a hitch or drawbar, the collapsible carrier comprising:
a central portion;
a first carrier arm hingedly connected to the central portion;
a first end portion connected to the first carrier arm;
a second carrier arm hingedly connected to the central portion; and
a second end portion connected to the second carrier arm,
wherein the collapsible carrier is configurable between an extended configuration and a stowed configuration such that:
   in the extended configuration, the central portion, the first carrier arm and the second carrier arm are axially aligned; and
   in the stowed configuration, the central portion, the first carrier arm and the second carrier arm are non-coplanar.

Preferably, the central portion is adapted for connection to a hitch or drawbar. Preferably, the central portion can be adapted to connect directly to a hitch or drawbar, or using an intermediary device, such as a hitch riser.

Preferably, the first carrier arm and the second carrier arm hingedly connected at opposite ends of the central portion.

Preferably, the first carrier arm is located and/or connected between the first end portion and the central portion. Preferably, the first carrier arm is located and/or connected between the first end portion and the first end of the central portion.

Preferably, the second carrier arm is located and/or connected between the second end portion and the central portion. Preferably, the second carrier arm is located and/or connected between the second end portion and the second end of central portion.

Preferably, the first end portion is hingedly connected to the first carrier arm such that the first end portion is pivotable or rotatable about or relative to the first carrier arm. Preferably, the first end portion is pivotable or rotatable about or relative to the first carrier arm between 0° and 135°. More preferably, the first end portion is pivotable or rotatable about or relative to the first carrier arm between 0° and 90°.

Preferably, the second end portion is fixed relative to the second carrier arm. Preferably, the second end portion extends at an angle from the second carrier arm. Preferably, the second end portion extends at an angle between 0° and 90° from the second carrier arm. More preferably, the second end portion extends at an angle between 30° and 60° from the second carrier arm. In a preferred embodiment, the second end portion extends at an angle of approximately 45° from the second carrier arm.

Preferably, in the extended configuration wherein the central portion, the first carrier arm and the second carrier arm are axially aligned, the central portion, the first carrier arm and the second carrier arm are axially aligned along respective longitudinal axes of each of the central portion, the first carrier arm and the second carrier arm.

Preferably, in the stowed configuration wherein longitudinal axes of the first carrier arm and the second carrier arm are angled relative to a longitudinal axis of the central portion, the longitudinal axes of the first carrier arm and the second carrier arm are angled relative to the longitudinal axis of the central portion between 0° and 90°. More preferably, the longitudinal axes of the first carrier arm and the second carrier arm are angled relative to the longitudinal axis of the central portion between 30° and 90°.

Preferably, in the stowed configuration, the longitudinal axes of the first carrier arm and the second carrier arm are angled relative to a longitudinal axis of the central portion.

Preferably, the collapsible carrier further comprises a wheel chock connected to the second carrier arm. Preferably, the wheel chock includes two arms (a first wheel chock arm and a second wheel chock arm) configured to receive a portion of a tyre of a vehicle therein. Preferably, the first wheel chock arm and the second wheel chock arm are arranged at approximately 135° relative to each other. Preferably, the wheel chock is arranged to move between a first configuration and a second configuration. Preferably, the wheel chock is arranged to move between a first configuration and a second configuration by rotating about a central axis that extends perpendicular to a central axis of the second carrier arm. Preferably, in the first configuration, the wheel chock has the first wheel chock arm parallel to the second carrier arm. Preferably, in the second configuration, the second wheel chock arm is parallel to the second carrier arm. Preferably, in use, a tyre of a vehicle is located between and in abutment with the second end portion and the wheel chock in the second configuration.

Preferably, the collapsible carrier further comprises a ramp adapted to connect to the first end portion. Preferably, the ramp comprises two ramp portions adapted to be connected end to end.

In another aspect, the invention provides a method for stowing a collapsible carrier, the method including:
moving a collapsible carrier from an extended configuration for receiving a two-wheeled vehicle thereon for transport to a stowed configuration,
wherein in the extended configuration, a central portion connected between a first carrier arm and a second carrier arm are axially aligned; and
wherein in the stowed configuration, the central portion, the first carrier arm and the second carrier arm are non-coplanar.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is a perspective view of a collapsible carrier according to a preferred embodiment of the present invention;

FIG. 2 is a perspective view of the collapsible carrier connected to a hitch riser;

FIG. 3 is a side view of the collapsible carrier;

FIG. 4 is a side view of the collapsible carrier in use with a ramp;

FIGS. 5 and 6 show the collapsible carrier in the stowed configuration;

FIG. 7 shows the collapsible carrier in a partially stowed configuration;

FIG. 8 shows the collapsible carrier in the extended configuration attached to a vehicle;

FIG. 9 shows the collapsible carrier in the extended configuration with a motorbike loaded thereon.

### DETAILED DESCRIPTION OF PREFERRED EMBODIMENTS

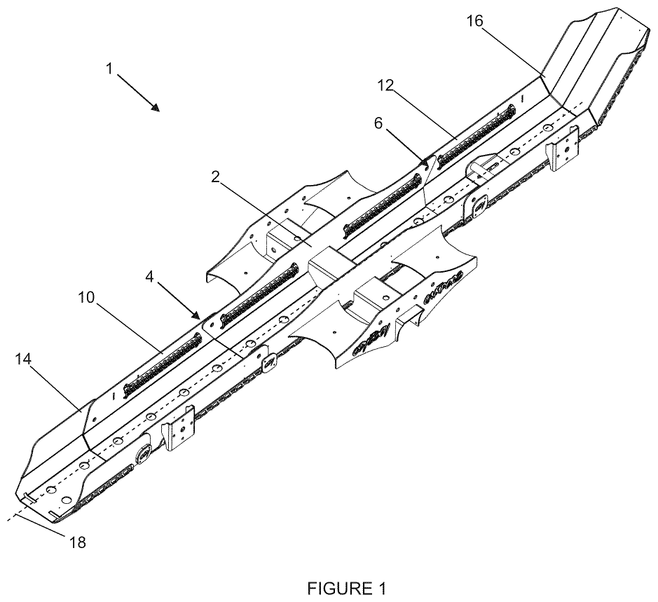

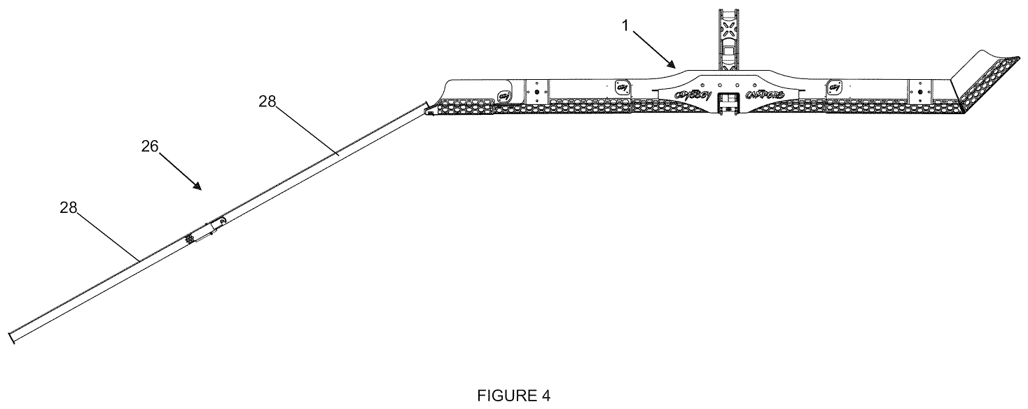

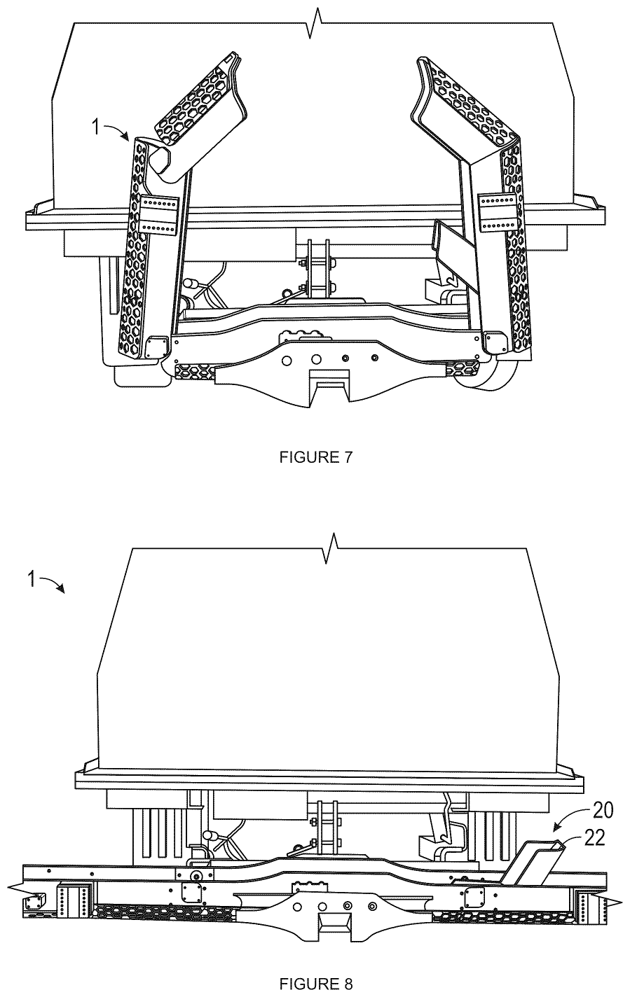

FIGS. 1 to 9 illustrate a collapsible carrier 1 adapted for connecting to a hitch or drawbar that is configurable between an extended configuration and a stowed configuration.

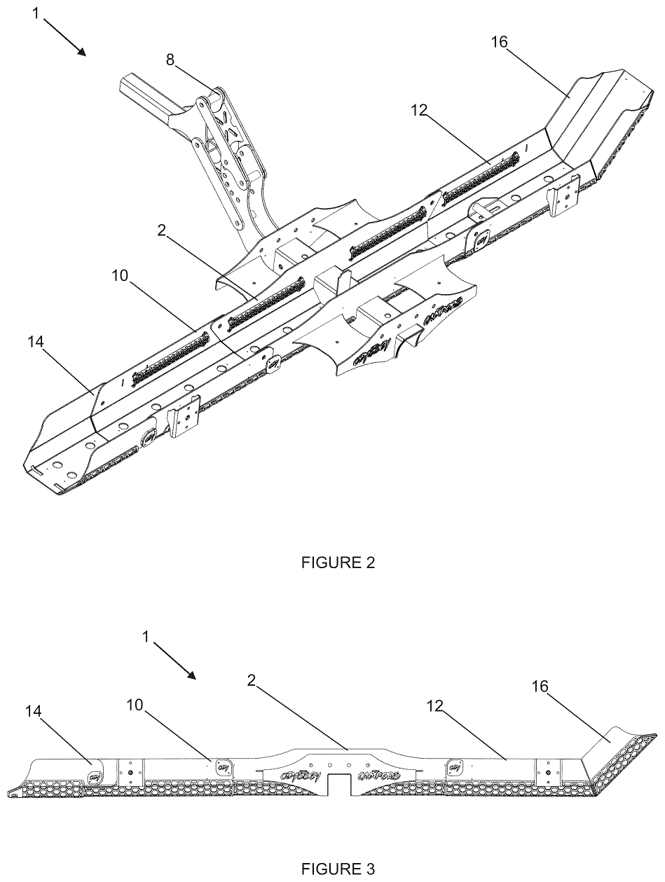

The collapsible carrier 1 includes a central portion 2 having a first end 4 and a second end 6. The central portion 2 may be adapted for connection to a hitch or drawbar. In some embodiments, the central portion can be adapted to connect directly to a hitch or drawbar, or using an intermediary device, such as a hitch riser 8 as shown in FIG. 2.

The central portion 2 is located between a first carrier arm 10 and a second carrier arm 12.

The first carrier arm 10 is hingedly connected to the central portion 2 at the first end 4 of the central portion 2. Similarly, the second carrier arm 12 is hingedly connected to the central portion 2 but at the second end 6 of the central portion 2. That is, the first carrier arm 10 and the second carrier arm 12 may be thought of as being connected at opposite ends of the central portion 2.

The collapsible carrier 1 also includes a first end portion 14 connected to the first carrier arm 10 and a second end portion 16 connected to the second carrier arm 12.

As such, the first carrier arm 10 may be located and/or connected between a first end portion 14 and the central portion 2. In particular, the first carrier arm 10 may be located and/or connected between the first end portion 14 and the first end 4 of the central portion 2.

Similarly, the second carrier arm 12 may be located and/or connected between a second end portion 16 and the central portion 2. In particular, the second carrier arm 12 may be located and/or connected between the second end portion 16 and the second end 6 of central portion 2. The first end portion and the second end portion will be described in more detail below.

The hinged connections allow the first carrier arm 10 and second carrier arm 12 to move relative to the central portion 2 (which is fixed to a drawbar or tow hitch, in use) so as to allow the collapsible carrier 1 to be collapsed and made more compact for transport when not carrying a vehicle.

The first end portion 14 may be connected at an end of the first carrier arm 10 opposite to the end connected to the central portion 2. Similarly, the second end portion 16 may be connected at an end of the second carrier arm 12 opposite to the end connected to the central portion 2.

The first end portion 14 is hingedly connected to the first carrier arm 10 such that the first end portion 14 is pivotable or rotatable about or relative to the first carrier arm 10 which is fixed in place. The first end portion 14 is therefore pivotable or rotatable about or relative to the first carrier arm 10 between 0° (e.g., coaxial along a longitudinal axis) and 90° (e.g., perpendicular to the longitudinal axis of the first carrier arm). However, in some embodiments, the first end portion 14 may be pivotable or rotatable about or relative to the first carrier arm 10 by up to between 0° and 135°.

In the illustrated embodiment, the second end portion 16 is fixed relative to the second carrier arm 12 and extends at an angle from the second carrier arm 12. In the illustrated embodiment, the second end portion 16 extends at an angle of approximately 45° from the second carrier arm 12. However, in some embodiments, the second end portion may be hingedly connected to the second carrier arm 12.

In some embodiments, the second end portion 16 may extend at an angle between 0° and 90° from the second carrier arm 12 and in some more particular embodiments, the second end portion 16 may extend at an angle between 30° and 60° from the second carrier arm 12.

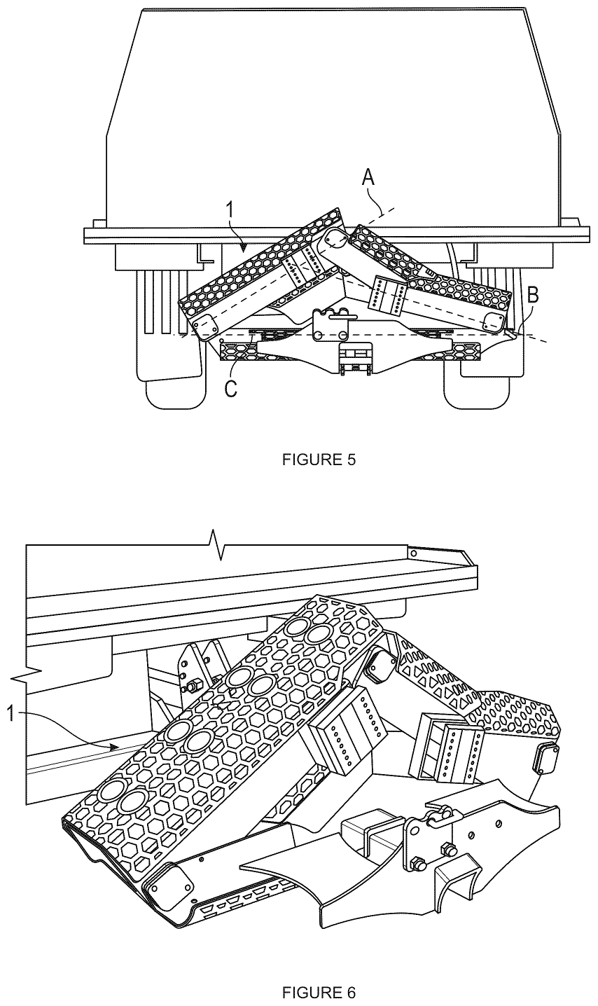

As described elsewhere, the collapsible carrier 1 is configurable between an extended configuration (see FIGS. 3 and 8) and a stowed configuration (see FIGS. 5 and 6).

In the extended configuration, the central portion 2, the first carrier arm 10 and the second carrier arm 12 are axially aligned. That is, the central portion 2, the first carrier arm 10 and the second carrier arm 12 may be axially aligned along respective longitudinal axes (or a shared axis 18) of each of the central portion 2, the first carrier arm 10 and the second carrier arm 12.

In the stowed configuration, the central portion 2, the first carrier arm 10 and the second carrier arm 12 are non-coplanar.

The longitudinal axes A, B of the first carrier arm 10 and the second carrier arm 12 may be angled relative to a longitudinal axis C of the central portion 2. That is, the axes of the first carrier arm and the second carrier arm may be angled relative to the axis of the central portion between 0° and 90°. In some embodiments, the axes of the first carrier arm 10 and the second carrier arm 12 may be angled relative to the axis of the central portion between 30° and 90°.

Put another way, axes C, A, B of the central portion 2, the first carrier arm 10 and the second carrier arm 12 are non-coplanar and/or not axially aligned.

The collapsible carrier 1 may also include a wheel chock 20 connected to the second carrier arm 12 that is configured to move between a first configuration and a second configuration which allows a two-wheeled vehicle to be loaded onto and kept in place on the collapsible carrier 1.

In the illustrated embodiment, the wheel chock 20 includes two arms in the form of a first wheel chock arm 22 and a second wheel chock arm 24, configured to receive a portion of a tyre of a vehicle therein.

The first wheel chock arm 22 and the second wheel chock arm 24 are arranged at approximately 135° relative to each other.

As described elsewhere, the wheel chock 20 is arranged to move between a first configuration and a second configuration which is facilitated by rotating about an axis that extends perpendicular to a longitudinal axis of the second carrier arm 12.

In the first configuration, the wheel chock 20 has the first wheel chock arm 22 parallel to the second carrier arm 12 and the second wheel chock arm 24 is angled relative to the first wheel chock arm 22 accordingly.

In the second configuration, the second wheel chock arm 24 is parallel to the second carrier arm 12 and the first wheel chock arm 22 is angled relative to the second wheel chock arm 24 accordingly.

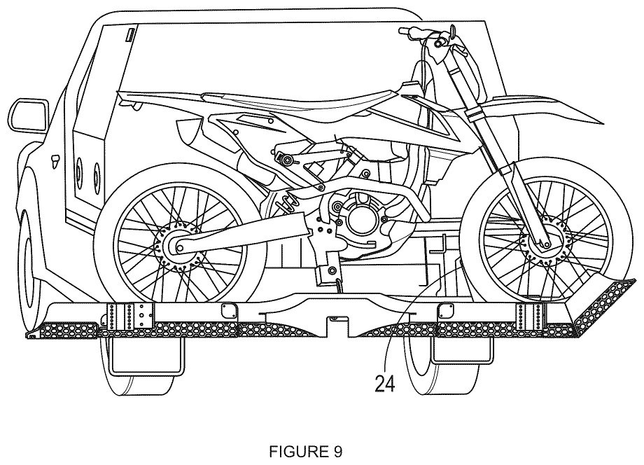

In use, a tyre of a vehicle (i.e., a two-wheeled vehicle) is located between and in abutment with the second end portion 16 and the wheel chock 20 in the second configuration (see FIG. 9).

The collapsible carrier 1 may also include a ramp 26 adapted to connect to the first end portion 14 to assist with loading a vehicle onto the collapsible carrier 1 from the ground without having to lift the entire vehicle directly onto the carrier.

The ramp 26 may include two ramp portions 28, 30 adapted to be connected end to end as shown in the illustration, or be formed as a single elongate member.

In use, the collapsible carrier is connected to the hitch/drawbar fastened and secured with bolts to mount correctly and to avoid movement. The arms of the carrier are then to be moved into the extended configuration until completely opened and flat. The motorcycle/bicycle may then be loaded using the ramp by pushing the motorcycle/bicycle upwards onto the collapsible carrier. The motorcycle/bicycle is then secured to the collapsible carrier 1. The motorcycle or bicycle may be secured using tie-down points or straps.

The ramp may be connected to the first end portion 14 by way of a pin that is received through apertures formed in both that can be aligned. Other connecting mechanisms may be used.

The foldable clamshell design of the carrier enables it to collapse into a compact form, facilitating easy storage when not in use. This design allows consumers to store the carrier easily and compact in small spaces when not in use.

Its versatility allows for connection to the hitch of a vehicle or the drawbar of a trailer, offering flexibility in transportation options.

A ramp assists with some embodiments in loading vehicles onto the carrier from the ground, eliminating the need for lifting the entire vehicle directly onto the carrier.

The carrier's adjustable configuration allows for easy transitioning between extended and stowed configurations, catering to various transport needs.

With the inclusion of a wheel chock in some embodiments, the carrier enhances the security of vehicle transportation, ensuring stability during transit.

In compliance with the statute, the invention has been described in language more or less specific to structural or methodical features. The term “comprises” and its variations, such as “comprising” and “comprised of” is used throughout in an inclusive sense and not to the exclusion of any additional features.

It is to be understood that the invention is not limited to specific features shown or described since the means herein described comprises preferred forms of putting the invention into effect.

The invention is, therefore, claimed in any of its forms or modifications within the proper scope of the appended claims appropriately interpreted by those skilled in the art.

1. A collapsible carrier adapted for connecting to a hitch or drawbar, the collapsible carrier comprising:
a central portion;
a first carrier arm hingedly connected to the central portion;
a first end portion connected to the first carrier arm;
a second carrier arm hingedly connected to the central portion; and
a second end portion connected to the second carrier arm,
wherein the collapsible carrier is configurable between an extended configuration and a stowed configuration such that:
in the extended configuration, the central portion, the first carrier arm and the second carrier arm are axially aligned; and
in the stowed configuration, the central portion, the first carrier arm and the second carrier arm are non-coplanar.

2. The collapsible carrier according to claim 1, wherein the first carrier arm and the second carrier arm are hingedly connected to the central portion at opposite ends of the central portion.

3. The collapsible carrier according to claim 2, wherein the first carrier arm is located and/or connected between the first end portion and the central portion.

4. The collapsible carrier according to claim 3, wherein the second carrier arm is located and/or connected between the second end portion and the central portion.

5. The collapsible carrier according to claim 1, wherein the first end portion is hingedly connected to the first carrier arm such that the first end portion is pivotable or rotatable about or relative to the first carrier arm.

6. The collapsible carrier according to claim 1, wherein the first end portion is pivotable or rotatable about or relative to the first carrier arm between 0° and 135° or between 0° and 90°.

7. The collapsible carrier according to claim 1, wherein the second end portion is fixed relative to the second carrier arm.

8. The collapsible carrier according to claim 1, wherein the second end portion extends at an angle from the second carrier arm.

9. The collapsible carrier according to claim 1, wherein in the extended configuration and wherein the central portion, the first carrier arm and the second carrier arm are axially aligned, the central portion, the first carrier arm and the second carrier arm are axially aligned along respective longitudinal axes of each of the central portion, the first carrier arm and the second carrier arm.

10. The collapsible carrier according to claim 1, wherein in the stowed configuration and wherein longitudinal axes of the first carrier arm and the second carrier arm are angled relative to a longitudinal axis of the central portion, the longitudinal axes of the first carrier arm and the second carrier arm are angled relative to the longitudinal axis of the central portion between 0° and 90°.

11. The collapsible carrier according to claim 10, wherein the longitudinal axes of the first carrier arm and the second carrier arm are angled relative to the longitudinal axis of the central portion between 30° and 90°.

12. The collapsible carrier according to claim 1, wherein the collapsible carrier further comprises a wheel chock connected to the second carrier arm.

13. The collapsible carrier according to claim 12, wherein the wheel chock includes two arms comprising a first wheel chock arm and a second wheel chock arm, wherein the two arms configured to receive a portion of a tyre of a vehicle therein.

14. The collapsible carrier according to claim 13, wherein the first wheel chock arm and the second wheel chock arm are arranged at approximately 135° relative to each other.

15. The collapsible carrier according to claim 14, wherein the wheel chock is arranged to move between a first configuration and a second configuration.

16. The collapsible carrier according to claim 15, wherein the wheel chock is arranged to move between a first configuration and a second configuration by rotating about a central axis that extends perpendicular to a central axis of the second carrier arm, wherein:
in the first configuration, the first wheel chock arm is parallel to the second carrier arm; and
in the second configuration, the second wheel chock arm is parallel to the second carrier arm.

17. The collapsible carrier according to claim 16, wherein in use, a tyre of a vehicle is located between and in abutment with the second end portion and the wheel chock in the second configuration.

18. The collapsible carrier according to claim 1, wherein the collapsible carrier further comprises a ramp adapted to connect to the first end portion.

19. A method for stowing a collapsible carrier, the method including:
moving a collapsible carrier from an extended configuration for receiving a two-wheeled vehicle thereon for transport to a stowed configuration,
wherein in the extended configuration, a central portion connected between a first carrier arm and a second carrier arm are axially aligned; and
wherein in the stowed configuration, the central portion, the first carrier arm and the second carrier arm are non-coplanar.
